(19) United States
(12) Patent Application Publication
(10) Pub. No.: US 2015/0273997 A1
(43) Pub. Date: Oct. 1, 2015

(54) POWERTRAIN FOR INTERNAL-COMBUSTION ENGINE VEHICLE WITH COMBINATION OF PISTON ENGINE AND ROTARY ENGINE

(71) Applicants: Myungkoo KANG, Busan (KR); Hyo Jeong Jeon, Busan (KR)

(72) Inventors: Myungkoo KANG, Busan (KR); Hyo Jeong Jeon, Busan (KR)

(21) Appl. No.: 14/674,116

(22) Filed: Mar. 31, 2015

(30) Foreign Application Priority Data
Mar. 31, 2014 (KR) 10-2014-0037609

(51) Int. Cl. B60K 5/08; F16H 3/00; B60K 17/02; F02B 73/00; F02B 53/14

(52) U.S. Cl. CPC B60K 5/08; F02B 73/00; F02B 53/14; B60K 17/02; F16H 3/006

(57) ABSTRACT

Disclosed herein is a powertrain for an internal-combustion engine vehicle with a combination of a piston engine and a rotary engine. The powertrain includes a piston engine (10), a transmission (20), and a rotary engine (30). The piston engine (10) is provided as a primary power source. The transmission (20) is configured such that power produced from the piston engine (10) is transmitted to the transmission (20) through an output shaft (1). The rotary engine (30) is provided as a secondary power source and shares the output shaft (1) with the piston engine (10) and transmits produced power to the transmission (20). Power produced from the piston engine and power produced from the rotary engine are simultaneously or selectively transmitted to the transmission. Therefore, the present invention can have the advantages of the respective engines, whereby the performance and fuel efficiency per a unit engine displacement can be maximized.

### BACKGROUND OF THE INVENTION

1. Field of the Invention

The present invention generally relates to powertrains for internal-combustion engine vehicles. More particularly, the present invention relates to a powertrain for an internal-combustion engine vehicle with a combination of a piston engine and a rotary engine that is configured such that the piston engine and the rotary engine share the same output shaft so that advantages of the respective engines can be maximally used, whereby the performance and fuel efficiency per a unit engine displacement can be maximized.

2. Description of the Related Art

Recently, as problems of exhaustion of fossil fuel and environment pollution have become social issues, interest in electric vehicles and hybrid vehicles has become increasingly common. However, most vehicles on roads still use internal-combustion engines as a means for combusting fuel and producing kinetic energy.

Piston engines are generally used as internal-combustion engines. Piston engines include a piston and a crankshaft that reciprocate in a cylinder. As in all internal-combustion engines, the performance of a piston engine completely depends on the capacity, that is, the displacement, of a cylinder that produces kinetic energy. The most common method for enhancing the performance of a piston engine is an increase of an engine displacement. However, this results in an increase of the weight of the vehicle.

The increase of the weight of a vehicle reduces fuel efficiency, in other words, the distance that the vehicle can move per unit fuel. If vehicles move on a road that has normal driving conditions on which the vehicles can exhibit their intended performance, there is no problem. However, on an urban road that is congested, vehicles with high engine displacements inefficiently waste their output power despite being not able to effectively move. Thus, the fuel efficiency is markedly reduced. To avoid these problems, a variety of methods for enhancing thermal efficiency of an internal-combustion engine and reducing fuel consumption have been studied.

When a vehicle moves on a road, the conditions of the engine thereof are continuously varied depending on driving conditions. That is, after the vehicle that has started and accelerated reaches a predetermined speed, it may cruise at a constant speed.

Furthermore, when the vehicle moves downhill, a driver generally does not accelerate the vehicle. However, when a vehicle slows down or stops, such as at stop sign, the vehicle has to re-accelerate to reassume the desired driving speed. During such driving processes, fuel consumption is increased when the vehicle accelerates because the engine is fully operated and the output thereof is maximally increased.

Meanwhile, fuel cut, idle stop and go (ISG), and cylinder on demand (COD, or cylinder deactivation) technologies that operate an engine taking driving conditions of a vehicle into account were proposed to improve fuel efficiency despite maintaining the structure and thermal efficiency of the existing piston engines.

In a deceleration section, i.e., on a downhill road, even if no fuel is supplied to an engine, the vehicle can move without stopping. This refers to the fuel cut technology. Furthermore, when the vehicle is in place while being in an ignition-on state, the engine idles within a range from about 800 rpm to about 1,000 rpm. In this state, the ISG technology stops the operation of the engine and reduces fuel consumption attributable to idling of the engine.

During cruising driving, the vehicle does not require a large amount of power. Thus, there is no need for increasing the output of the engine to the maximum. According to the known fact, even if the output of the engine is in only a range from 20 horsepower to 30 horsepower, the vehicle can achieve 90% of the purpose of the cruising driving. For example, in a 300 horsepower engine, it is very inefficient in an aspect of fuel efficiency to operate the engine to produce only 30 horsepower, because pumping loss is increased. In other words, there is no need for operating all cylinders of an eight-cylinder engine.

Given this, the cylinder on demand (or cylinder deactivation) technology controls a variable cam shaft having the structure of

FIG. 3 and thus interrupts fuel injection and ignition of specific cylinders (of eight cylinders, four cylinders indicated by separate marks), thus preventing fuel waste.

The driving conditions of a vehicle vary from moment to moment. During acceleration, comparatively large torque is required. During cruising, only comparatively small torque is needed. Give this, driving of a vehicle with an internal-combustion engine rather than a hybrid vehicle will be ideal if the engine is fully operated for acceleration; the COD technology is used for cruising; the fuel cut technology is used for deceleration; and the vehicle moves in the ISG mode when stopping. The COD technology is already used in vehicles marketed under the brand name of AUDI RS7 and Bentley V8. When cruising on a highway, only four cylinders of the eight cylinders are used. For acceleration, all of the eight cylinders are operated. For cruising, a piston head and a crankshaft of each of the four corresponding cylinders are driven. To reduce passive resistance caused during this process, the COD technology uses an air spring effect in which the variable cam shaft closes valves and thus compressive resistance caused in a compressive stroke can be used again in an explosive stroke in which there is no explosion.

Thanks to such an air spring effect, compressive resistance of the piston that is driven without explosion is offset and removed, and only frictional resistance of the piston remains. Although it is known that the fuel efficiency of cruising driving on a highway is improved by 30%, substantial fuel efficiency improvement effect of the COD technology is not satisfactory because the piston engine is based on reciprocating motion. Therefore, unlike intended, the substantial fuel efficiency improvement effect of the COD technology is only approximately 5% to 7%. Moreover, only when the rpm of the piston engine is higher than a range from 2,000 rpm to 3,000 rpm can the COD function be operated. Therefore, in urban driving that requires repeated moving and stopping, the fuel efficiency improvement effect is further reduced.

Meanwhile, General Motors is developing a dynamic skip fire (DSF) technology that is improved from the COD technology. In the COD technology, all of the eight cylinders of the eight-cylinder engine are operated when high output power is required. If there is spare output power, only the four cylinders are operated while the other four cylinders are passively driven. The DSF technology is configured such that if there is spare output power, fuel injection and combustion are not conducted in specific cylinders under the control of a computer. Depending on driving conditions, only one, two, three, four, or eight cylinders may be operated. However, a problem of abnormal vibrations attributable to circulation explosion of the cylinders is not still solved.

Furthermore, there are disadvantages in that only when there is spare output power can the DSF function be operated, and specific rotation resistance of a piston that is passively operated and not involved in explosion is larger than specific rotation resistance of the rotary engine. Consequently, DSF technology is only an expansion of the fuel cut function for piston engines and is provided only to reduce fuel waste under control of a computer during deceleration of a vehicle. Therefore, it is preferable to positively use regenerative braking technology for hybrid vehicles in terms of fuel efficiency improvement effect.

Scalzo piston deactivation technology was proposed in an effort to overcome of technical disadvantages of the cylinder deactivation function of the piston engine. As shown in FIG. 5, this technology is configured such that using three cylinders as a single unit, one, two, or three pistons are involved in explosion. This technology has an advantage of improvement in fuel efficiency, but the structure thereof is complex, increasing the production cost of an engine. Thus, this technology is not still commercialized.

Meanwhile, with regard to rotary engines, a technology for increasing fuel efficiency in cruising of highway driving was proposed. As shown in FIG. 6, this technology is characterized in that a rotary engine including two rotors and functioning as a main engine, and another rotary engine including a single small rotor and provided for use in cruising are connected on the same output shaft. Given the fact that there is no need for high torque in cruising driving and the rotary engine can rotate at a high speed, this technology can improve the fuel efficiency in such a way that in high-speed cruising driving of 120 km/h or more, only the small rotary engine is operated while the large rotary engine is passively driven

Although this technology can improve the fuel efficiency of a vehicle in highway driving, there are still basic problems of the rotary engine in which the fuel efficiency is very low in low-speed driving and ignition is not reliable at low temperature.

Furthermore, there is no method of solving problems of high emission, low durability of the engine, and oil burning. Therefore, commercial applicability of this technology is also very low.

### PRIOR ART DOCUMENT

### Patent Document

Korean Patent Unexamined Publication No. 2012-0063408

### SUMMARY OF THE INVENTION

Accordingly, the present invention has been made keeping in mind the above problems occurring in the prior art, and the present invention is introduced to improve a cylinder on demand (or cylinder deactivation) technology, which is one of technologies for reducing fuel consumption of internal-combustion engines, and an object of the present invention is to provide a powertrain that is configured such that, in order to enhance the performance of an internal-combustion engine vehicle, an engine can be selectively fully or partially operated depending on driving conditions of a road even though an engine displacement is increased, whereby the fuel efficiency, the performance, the structure, and the operating mechanism can be markedly improved.

In order to accomplish the above object, the present invention provides a powertrain for an internal-combustion engine vehicle with a combination of a piston engine and a rotary engine. The powertrain include: a piston engine provided as a primary power source; a transmission configured such that power produced from the piston engine is transmitted to the transmission through an output shaft; and a rotary engine provided as a secondary power source, the rotary engine sharing the output shaft with the piston engine and transmitting produced power to the transmission, wherein power produced from the piston engine and power produced from the rotary engine are simultaneously or selectively transmitted to the transmission.

The piston engine, the rotary engine, and the transmission may be coaxially disposed, and a clutch may be provided between the piston engine and the rotary engine. The power produced from the rotary engine may be directly transmitted to the transmission, and the clutch may control only the power produced from the piston engine and transmitted to the transmission.

The piston engine, the rotary engine, and the transmission may be coaxially disposed, and a clutch may be provided between the piston engine and the rotary engine. The power produced from the piston engine may be directly transmitted to the transmission, and the clutch may control only the power produced from the rotary engine and transmitted to the transmission.

The rotary engine, the piston engine, and the transmission may be coaxially disposed, and a clutch may be provided between the rotary engine and the transmission. The power produced from the piston engine may be directly transmitted to the transmission, and the clutch may control only the power produced from the rotary engine and transmitted to the transmission.

The piston engine, the rotary engine, and the transmission may be coaxially disposed, and a clutch may be provided between the rotary engine and the transmission. The power produced from the piston engine may be directly transmitted to the transmission, and the clutch may control only the power produced from the rotary engine and transmitted to the transmission.

The piston engine, the rotary engine, and the transmission may be coaxially disposed. The power produced from the piston engine and transmitted to the transmission may be controlled by a first clutch. The power produced from the rotary engine and transmitted to the transmission may be controlled by a second clutch.

The piston engine, the rotary engine, and the transmission may be coaxially disposed, and a dual clutch may be provided between the piston engine and the rotary engine. The dual clutch may control the powers respectively produced from piston engine and the rotary engine and transmitted to the transmission.

The piston engine, the rotary engine, and the transmission may be coaxially disposed, and a dual clutch may be provided between the rotary engine and the transmission. The dual clutch may control the powers respectively produced from piston engine and the rotary engine and transmitted to the transmission.

### BRIEF DESCRIPTION OF THE DRAWINGS

The above and other objects, features and advantages of the present invention will be more clearly understood from the following detailed description taken in conjunction with the accompanying drawings, in which:

FIGS. 1A through 1H are schematic views illustrating various embodiments of a powertrain for vehicles according to the present invention;

FIGS. 2A through 2H are schematic views illustrating various embodiments of a powertrain with a parallel hybrid according to the present invention;

FIG. 3 illustrates the operation of a variable camshaft of a COD (cylinder on demand) system used in a conventional piston engine;

FIG. 4 is a schematic view showing the operation of the cylinder of the COD system used in the conventional piston engine;

FIG. 5 is a schematic view showing a Scalzo piston deactivation technology used in the conventional piston engine; and

FIG. 6 is a view showing the construction of an idea introduced to improve fuel efficiency in high-speed cruising conditions of a conventional rotary engine.

### DESCRIPTION OF THE PREFERRED EMBODIMENTS

Hereinafter, an embodiment of the present invention will be described with reference to the attached drawings. Detailed descriptions of some functions or configurations will be omitted if they do not relate to the technical characteristics of the present invention or are known to one of ordinary skill in the art to which this invention belongs.

The present invention relates to a powertrain for a vehicle.

The powertrain according to the present invention includes a piston engine 10 and a rotary engine 30 that generate power, and a transmission 20 that converts the generated power into appropriate rotational force and outputs it. The powertrain is characterized in that powers respectively generated from the piston engine 10 and the rotary engine 30 are simultaneously or selectively transmitted to the transmission 20.

The piston engine 10 is a primary power source that generates power for driving the vehicle. In this embodiment, the piston engine 10 may comprises a typical piston engine including a piston and a crankshaft. The reciprocating motion of the piston is converted into rotary motion before being transmitted to the transmission 20 by an output shaft 1.

The rotary engine rotary-engine 30 is a secondary power source that generates power for driving the vehicle. The rotary engine rotary-engine 30 may comprise a typical rotary engine in which a triangular rotor with rounded edges rotates in an elliptical combustion chamber to conduct strokes including intake, compression, power, and exhaust. The rotary motion of the rotor is transmitted to the transmission 20 by the output shaft 1. That is, power produced from the rotary engine is transmitted to the transmission 20 by the output shaft 1 that is also used to transmit power from the piston engine to the transmission 20.

The reason why the powertrain according to the present invention includes both the piston engine and the rotary engine sharing the output shaft is because advantages of different kinds of operating mechanism can be selectively used. The torque output of the piston engine in a low rpm area is relatively superior, and the maximum torque and horsepower section thereof is closer to the low rpm area than that of the rotary engine. On the other hand, the torque and engine efficiency of the rotary engine are enhanced when the rpm thereof is over a predetermined rpm (i.e., about 2000 rpm). The maximum torque and horsepower section of the rotary engine is closer to a high rpm area than that of the piston engine. Therefore, in the high rpm area, large output can be produced even by a comparatively small engine.

As such, in the powertrain including both the piston engine and the rotary engine, the piston engine governs the low rpm section, and the rotary engine governs the high rpm section. An acceleration section is governed by both the piston engine and the rotary engine. Thus, in the low rpm area of 2000 rpm or less (low-speed driving and cruising driving), the piston engine that is higher in output and fuel efficiency than the rotary engine is used as the power source of the vehicle. In the high rpm area (outstrip or acceleration driving and high-speed driving), the rotary engine that is higher in output and fuel efficiency than the engine and is able to easily reach 9000 rpm is used as the power source.

Furthermore, during high-speed cruising, among the following methods: only the piston engine is operated; the piston engine and the rotary engine are operated at the same time and a higher-speed gear is engaged to use residual torque; and only the rotary engine is operated to increase the rpm, the most efficient method may be used.

Therefore, the present invention provides a technology that makes it possible to embody an engine that can improve the fuel efficiency of an internal-combustion engine despite retaining the maximum performance thereof but differ from a hybrid vehicle with a combination of a motor and an engine. Thus, the technology of the present invention is markedly superior in performance and fuel efficiency to a piston engine or a cylinder-on-demand technology including the piston engine.

The transmission 20 may comprises any one selected from among an automatic transmission, a manual transmission, a dual-clutch transmission (DCT). The automatic transmission includes a torque converter and a planetary gearbox. The manual includes a clutch and a manual gearbox. The DCT includes a dual clutch and a DCT gearbox.

The operating mechanism of transmitting power produced from each of the piston engine 10 and the rotary engine 30 to the transmission 20 will be described in detail with reference to the attached drawings.

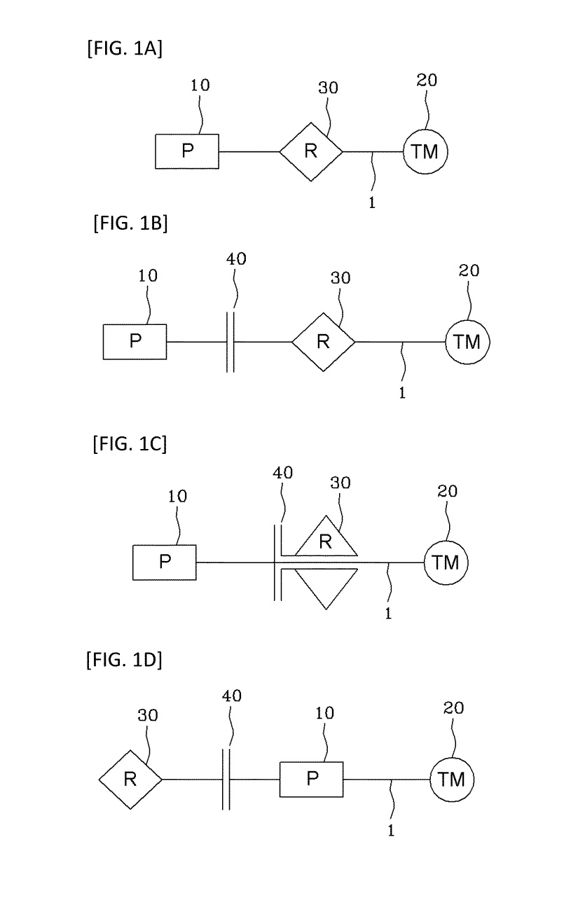

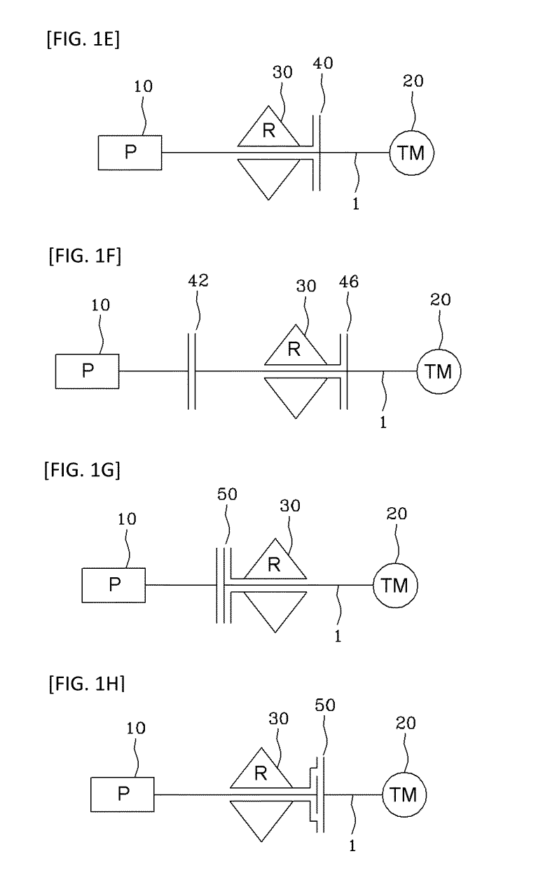

FIG. 1A illustrates a first embodiment according to the present invention. In this embodiment, the piston engine 10 and the rotary engine 30 share the output shaft 1 such that power produced from each of the piston engine 10 and the rotary engine can be directly transmitted to the transmission 20. This embodiment has a very simple structure. Although the positions of the piston engine 10 and the rotary engine 30 are switched, the operating mechanism thereof is the same.

The operating mechanism of this embodiment may include the cases where both the piston engine and the rotary engine are simultaneously operated, either the piston engine and the rotary engine is selectively operated, only the piston engine is operated, and only the rotary engine is operated. Furthermore, this embodiment is configured such that the piston engine and the rotary engine are directly connected to each other without a separate clutch provided therebetween. Therefore, even when only the rotary engine is operated the piston engine is also driven. However, in this case, the resistance increases because of the passive operation of the piston engine. Hence, it may be preferable that the operating mechanism in which only the rotary engine is operated be not used.

Depending on driving conditions of the vehicle, the selective operation of the piston engine and the rotary engine can be controlled by a computer. In detail, when the minimum power is required, only the piston engine is operated. When high power is required for outstrip or acceleration driving, both the piston engine and the rotary engine are simultaneously operated. Furthermore, when only the piston engine is operated, the rotor of the rotary engine is passively rotated. Here, the resistance resulting from the passive operation of the rotary engine is much smaller than that of the piston engine. This operating mechanism is thus available.

FIGS. 1B and 1C respectively illustrate second and third embodiments according to the present invention. Each of the second and third embodiments is characterized in that a clutch 40 is interposed between the piston engine 10 and the rotary engine 30.

The second embodiment is configured such that the clutch 40 controls only the power produced from the piston engine 10 and transmitted to the transmission 20. Furthermore, the operating mechanism of the second embodiment includes the cases where both the piston engine and the rotary engine are simultaneously operated, only the piston engine is operated, and only the rotary engine is operated. In such operating mechanism, when only the piston engine is operated, the rotary engine is passively rotated.

The third embodiment is configured such that the clutch 40 controls only power transmitted from the rotary engine 30 to the transmission 20. The operating mechanism of the third embodiment includes the cases where both the piston engine and the rotary engine are simultaneously operated, and only the piston engine is operated while the rotary engine is interrupted.

Particularly, if the clutch 40 is interposed between the piston engine 10 and the rotary engine 30 in the fashion of the third embodiment, the rotary engine conducts explosion operation when the rotor of the rotary engine along with the piston engine actively rotates at the same time, but when only the piston engine is operated, the rotor is involved in the rotation only for a short time regarding the operation of the vehicle because the rotary engine is in the interrupted state.

As well known in this art, the rotary engine is disadvantageous in that the rotor or a block must be replaced with a new one every a mileage ranging from about 100,000 km to about 200,000 km because of low durability of the rotary engine (for reference, the replacement cycle of parts of the piston engine is about 600,000 km). However, in the present invention in which the rotary engine is partially involved in the driving of the vehicle, even if the total mileage of the vehicle is one million km, the mileage in which the rotary engine is involved is less than 100,000 km. Therefore, until the vehicle is scrapped after purchase, it is unnecessary to replace the rotor or block with a new one. Furthermore, the partial involvement of the rotary engine can markedly mitigate an emission problem that is one of the disadvantages of the rotary engine. In addition, if LPG, ethanol, or hydrogen is used as fuel, the emission problem can be further mitigated.

The piston engine is advantageous in that: thanks to reciprocating motion, there is no compression leakage; emission is reduced because oil burning is not required; and high-pressure compression is possible, so that the engine can easily start up even in cold weather, and the torque is comparatively high in the low rpm area. However, the reciprocating motion makes it impossible to make high-speed rotation. If high-speed rotation is forcibly made, the piston and connecting rod are placed under stress and, consequently, the piston or the connecting rod may be damaged. Furthermore, each cylinder conducts a single explosion stroke every two turns of the output shaft. Thus, the rotation is uneven, so a heavy flywheel must be used.

However, because the rotary engine conducts epitrochoid motion, the rotation thereof in the high-speed area is uniform so a flywheel is not required. Therefore, the rotary engine can be operated at high speed over 10,000 rpm. Thanks to such uniform rotation of the rotary engine, it is not difficult, using the clutch, to control relationship between the piston engine and the rotary engine. Unlike this, in order to control the relationship between two piston engines, two output shafts must engage with each other at a precise predetermined contact point because of uneven rotation of each piston engine. Otherwise, the rotation of the piston engines becomes uneven, so that abnormal vibration is caused. However, the rotary engine is advantageous in that when the rpm thereof becomes a predetermined rpm or more, it neither impedes the rotation of the piston engine nor causes vibration even if any portion of the output shaft makes contact with the piston engine.

FIG. 1D illustrates a fourth embodiment of the present invention. Compared to the second embodiment, the positions of the piston engine 10 and the rotary engine 30 of the fourth embodiment are reversed from those of the second embodiment. In the fourth embodiment, the clutch 40 is configured such that it controls only the power produced from the rotary engine 30 and transmitted to the transmission 20.

Unlike the second embodiment, the fourth embodiment uses only two kinds of operating mechanism, including the case where both the piston engine and the rotary engine are simultaneously operated, the case where only the piston engine is operated while the rotary engine is interrupted. That is, this embodiment is configured such that a boosting function of the rotary engine can be used although during the solo operation of the piston engine the rotary engine is interrupted to remove resistance resulting from passive operation.

FIG. 1E illustrates a fifth embodiment according to the present invention. The fifth embodiment is characterized in that the clutch 40 is interposed between the rotary engine 30 and the transmission 20. The clutch 40 of the fifth embodiment controls only the power produced from the rotary engine 30 and transmitted to the transmission 20. Therefore, the operating mechanism of the fifth embodiment is almost the same as that of the above-mentioned third embodiment. That is, the fifth embodiment can have the same two kinds of operating mechanism as those of the third embodiment.

FIG. 1F illustrates a sixth embodiment according to the present invention. This embodiment is characterized in that two clutches are provided. In detail, the power produced from the piston engine 10 and transmitted to the output shaft 1 is controlled by a first clutch 42. The power produced from the rotary engine 30 and transmitted to the output shaft 1 is controlled by a second clutch 46.

FIGS. 1G and 1H respectively illustrate seventh and eighth embodiments according to the present invention. Each of the seventh and eighth embodiments is characterized in that a dual clutch 50 is used. In the seventh embodiment, the dual clutch 50 is interposed between the piston engine 10 and the rotary engine 30. In the eighth embodiment, the dual clutch 50 is interposed between the rotary engine 30 and the transmission 20. That is, the dual clutch 50 controls the respective powers produced from the piston engine 10 and the rotary engine 30 and transmitted to the transmission 20.

The operating mechanism of the seventh and eighth embodiments is almost the same as that of the sixth embodiment. That is, the operating mechanism of the seventh and eighth embodiments includes the cases where both the piston engine and the rotary engine are simultaneously operated, only the piston engine is operated while the rotary engine is interrupted, and only the rotary engine is operated while the piston engine is interrupted.

Hereinafter, the output transmitted to the transmission will be described with reference to each embodiment described above.

The output of the piston engine 10 is expressed as P, the output of the rotary engine 30 is R, the resistance when the rotary engine 30 is driven passively is −R, and the case where there is no passive resistance (i.e., there is no resistance due to rotation) is driven is 0.

The output of different kinds of operating mechanism of the above-mentioned embodiments is classified into two kinds of modes (a) of P−R and P+R, two kinds of modes (b) of P−0 and P+R, three kinds of modes (c) of P−R, P+R, and 0+R, and three kinds of modes (d) of P−0, P+R, and 0+R. (a) refers to the first embodiment, (b) refers to the third, fourth, and fifth embodiments, (c) refers to the second embodiment, and (d) refers to the sixth, seventh, and eighth embodiments. In the cases of the second, sixth, seventh, and eighth embodiments, a torque converter is not required because the clutch 40, 42, 50 is interposed between the piston engine 10 and the transmission 20.

Meanwhile, the present invention may include the case where at least one pressure equalizing valve, an intake valve, or an exhaust valve is provided between a compression chamber and a combustion chamber of the rotary engine 30. This case is configured to use an air spring and has almost the same configuration as that of opening a half of an exhaust valve using a variable valve to reduce compressive resistance in a compressive stroke of a cylinder that is driven in a COD of the conventional piston engine. Due to such use of the pressure equalizing valve, or the intake valve and the exhaust valve, although the rotary engine acts as a load when only the piston engine is operated, no pressure is applied to the rotary engine that is being driven, whereby the load can be markedly reduced.

The reason for this is because the rotary engine conducts epitrochoid motion rather than reciprocating motion and, thus, the passive resistance of the rotary engine is much less than that of the piston engine. Thereby, if the pressure equalizing valve or the intake valve and the exhaust valve are operated when the rotary engine is driven without explosion, no variation in pressure of the chamber is created, and the passive resistance of the rotary engine is further reduced. Therefore, if the present invention is configured such that the pressure equalizing valve or the intake valve and the exhaust valve are provided in the rotary engine, the resistance (−R) caused when the rotary engine is driven can be offset, whereby the output transmitted to the transmission can become P−0 rather than P−R.

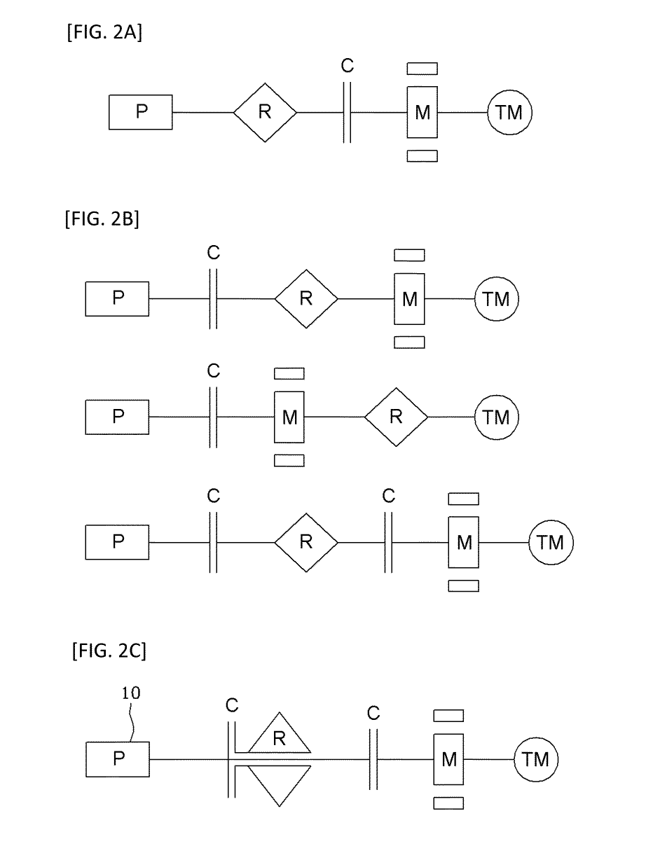

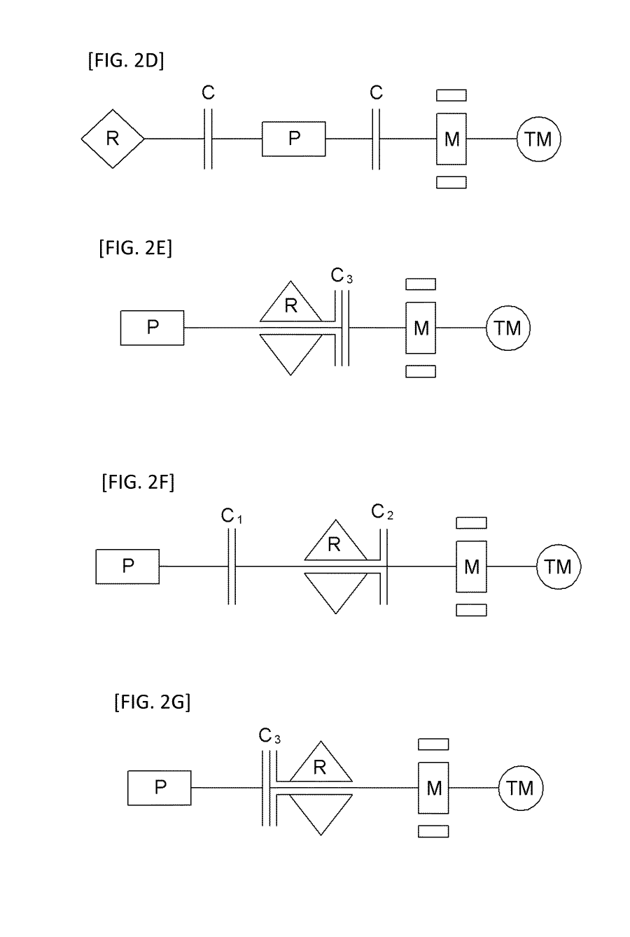

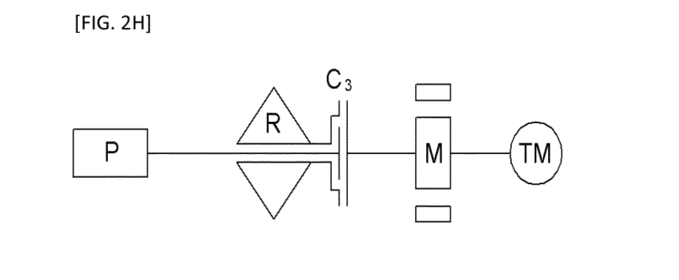

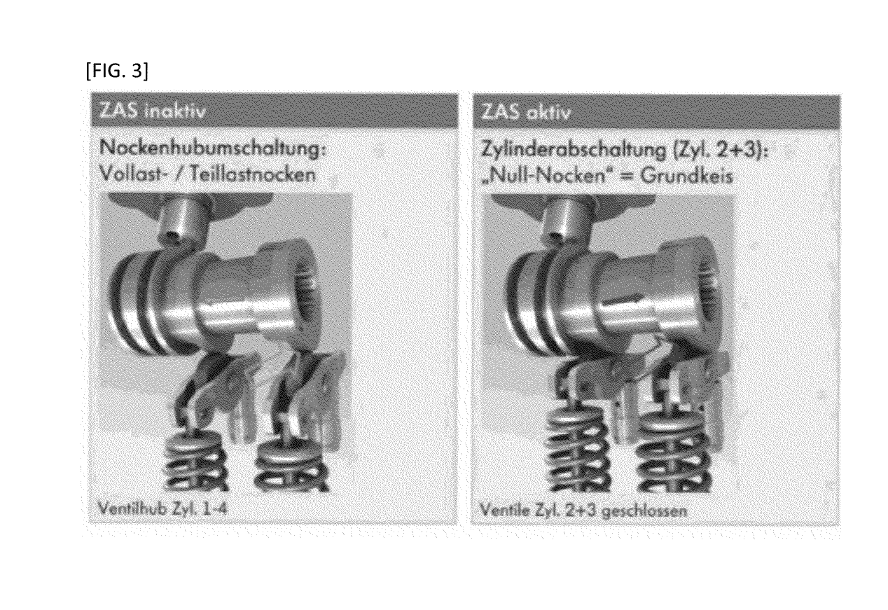

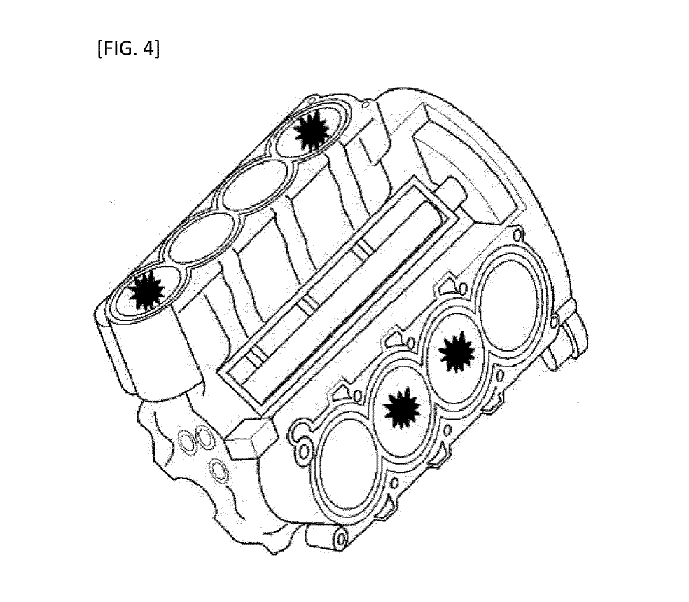

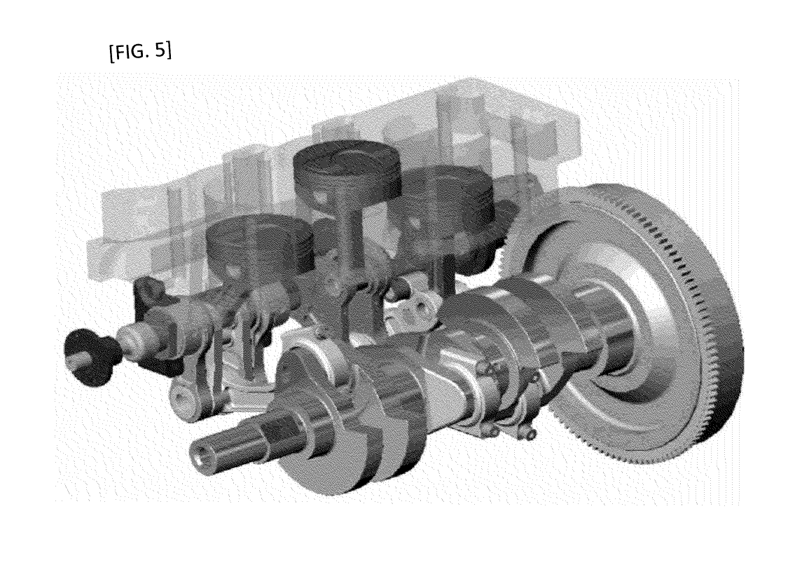

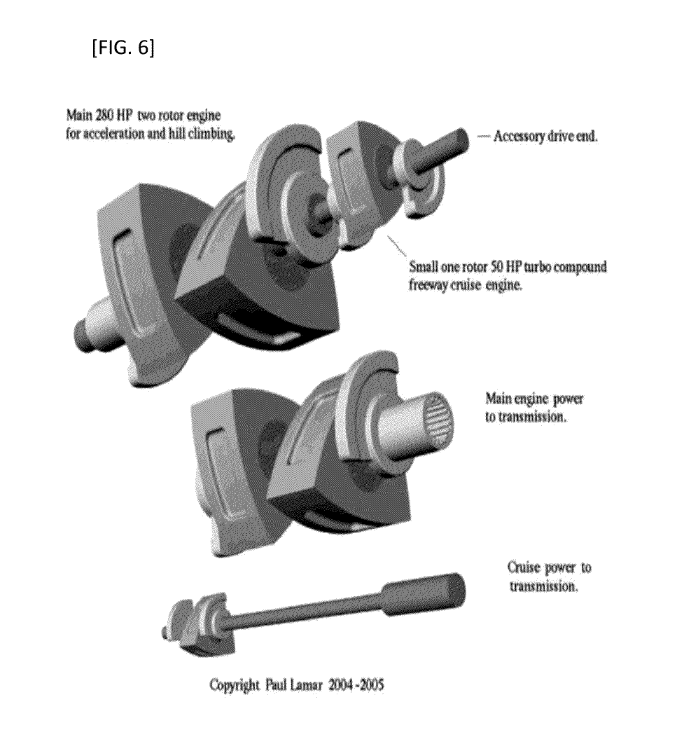

Furthermore, if a drive motor is used in each of the above-mentioned embodiments of the present invention, it can further have a parallel hybrid function. FIGS. 2A through 2H illustrate the respective cases where a drive motor is provided in each of the above-mentioned embodiments. Here, particularly, in the case of the second embodiment of FIG. 1B, three kinds of configurations are possible, as shown in FIG. 2B. In the drawings, P refers to a piston engine, R refers to a rotary engine, TM refers to a transmission, M refers to a drive motor, and C, C1, C2, or C3 refers to a clutch.

As such, the additional drive motor may be used to provide the functions of a hybrid vehicle. Classifying a cruising driving state into details, the powertrain may be controlled such that the drive motor governs low-speed cruising, the piston engine governs middle-speed cruising, and the rotary engine governs high-speed cruising. In this case, the performance and fuel efficiency can be further optimized in each driving state. Moreover, thanks to use of the drive motor, emission can be markedly reduced. When there is a need for rapid acceleration of the vehicle, all of the drive motor, the piston engine, and the rotary engine have only to be operated.

As a detailed example of the present invention, it is assumed that an imaginary vehicle has both a four-cylinder piston engine (referred to as P) with a displacement of 2000 cc and a rotary engine (referred to as R) with a displacement of 1000 cc. This vehicle will be compared to a COD commercial vehicle provided with an eight-cylinder piston engine with a displacement of 4000 cc.

First, the case where the vehicles are cruising at a constant speed will be explained. Although cruising driving of a vehicle does not require comparatively large power, conditions of the cruising driving may be changed depending on the driving speed of the vehicle. For the present invention, the piston engine governs low-speed cruising, and the rotary engine governs high-speed cruising. That is, in the present invention, even during cruising driving, an optimized rpm suitable for a current driving speed of the vehicle is produced using the minimized horsepower, thus reducing fuel consumption.

However, this cannot be applied to the COD commercial vehicle. The reason for this is because: only when the rpm of the piston engine is higher than a range from 2,000 rpm to 3,000 rpm can the COD function of the piston engine be operated; and only conversion from eight-cylinder to four-cylinder or from four-cylinder to eight-cylinder is possible while selection depending on characteristics of each engine is impossible.

Moreover, if the present invention is used in high-speed cruising, all of methods of driving only the piston engine, driving both the piston engine and the rotary engine while a higher-speed gear is engaged to use residual torque, and driving only the rotary engine can be used. With regard to selection of any one of these methods, it is preferable that the most efficient method be selected suitable for driving conditions and a driving speed. However, in the COD commercial vehicle, use of these methods itself is impossible.

Next, the case where the vehicles are operated on an urban road will be described. When a vehicle is operated on an urban road, generally, the vehicle repeatedly moves and stops. Thus, the rpm of the engine is seldom over 2,500 rpm. Therefore, the COD function of the commercial vehicle is useless on an urban road because the COD function is operated when the rpm of the engine is higher than a range from 2,000 rpm to 3,000 rpm. On the other hand, the present invention can be controlled such that when the vehicle moves at a low speed on an urban road, only the four-cylinder piston engine is operated. Consequently, the present invention can markedly reduce fuel consumption compared to that of the commercial vehicle.

As described above, in the present invention, a piston engine and a rotary engine that have different advantages and disadvantages share the same output shaft. Depending on road or driving conditions, both the piston engine and the rotary engine are simultaneously operated or either is selectively operated. Therefore, although an engine displacement is increased, intended performance can be sufficiently secured. Fuel efficiency of a vehicle using the technique of the present invention is markedly improved, compared to that of a typical vehicle with the same engine displacement.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A powertrain for an internal-combustion engine vehicle with a combination of a piston engine and a rotary engine, the powertrain comprising:
a piston engine (10) provided as a primary power source;
a transmission (20) configured such that power produced from the piston engine (10) is transmitted to the transmission (20) through an output shaft (1); and
a rotary engine (30) provided as a secondary power source, the rotary engine sharing the output shaft (1) with the piston engine (10) and transmitting produced power to the transmission (20),
wherein power produced from the piston engine and power produced from the rotary engine are simultaneously or selectively transmitted to the transmission.

2. The powertrain as set forth in claim 1, wherein the piston engine (10), the rotary engine (30), and the transmission (20) are coaxially disposed, and a clutch (40) is provided between the piston engine (10) and the rotary engine (30),
wherein the power produced from the rotary engine (30) is directly transmitted to the transmission (20), and the clutch (40) controls only the power produced from the piston engine (10) and transmitted to the transmission (20).

3. The powertrain as set forth in claim 1, wherein the piston engine (10), the rotary engine (30), and the transmission (20) are coaxially disposed, and a clutch (40) is provided between the piston engine (10) and the rotary engine (30),
wherein the power produced from the piston engine (10) is directly transmitted to the transmission (20), and the clutch (40) controls only the power produced from the rotary engine (30) and transmitted to the transmission (20).

4. The powertrain as set forth in claim 1, wherein the rotary engine (30), the piston engine (10), and the transmission (20) are coaxially disposed, and a clutch (40) is provided between the rotary engine (30) and the transmission (20),
wherein the power produced from the piston engine (10) is directly transmitted to the transmission (20), and the clutch (40) controls only the power produced from the rotary engine (30) and transmitted to the transmission (20).

5. The powertrain as set forth in claim 1, wherein the piston engine (10), the rotary engine (30), and the transmission (20) are coaxially disposed, and a clutch (40) is provided between the rotary engine (30) and the transmission (20),
wherein the power produced from the piston engine (10) is directly transmitted to the transmission (20), and the clutch (40) controls only the power produced from the rotary engine (30) and transmitted to the transmission (20).

6. The powertrain as set forth in claim 1, wherein the piston engine (10), the rotary engine (30), and the transmission (20) are coaxially disposed,
wherein the power produced from the piston engine (10) and transmitted to the transmission (20) is controlled by a first clutch (42), and
the power produced from the rotary engine (30) and transmitted to the transmission (20) is controlled by a second clutch (46).

7. The powertrain as set forth in claim 1, wherein the piston engine (10), the rotary engine (30), and the transmission (20) are coaxially disposed, and a dual clutch (50) is provided between the piston engine (10) and the rotary engine (30),
wherein the dual clutch (50) controls the powers respectively produced from piston engine (10) and the rotary engine (30) and transmitted to the transmission (20).

8. The powertrain as set forth in claim 1, wherein the piston engine (10), the rotary engine (30), and the transmission (20) are coaxially disposed, and a dual clutch (50) is provided between the rotary engine (30) and the transmission (20),
wherein the dual clutch (50) controls the powers respectively produced from piston engine (10) and the rotary engine (30) and transmitted to the transmission (20).
